(19) United States
(12) Patent Application Publication
(10) Pub. No.: US 2015/0151563 A1
(43) Pub. Date: Jun. 4, 2015

(54) PAPER PUNCH BINDER APPARATUS AND METHOD OF USE AND DOING BUSINESS

(71) Applicant: Stride Manufacturing, L.L.C., Reno, NV (US)

(72) Inventor: Brian R. Brennan, Verdi, NV (US)

(21) Appl. No.: 14/325,985

(22) Filed: Jul. 8, 2014

Related U.S. Application Data
(60) Provisional application No. 61/843,700, filed on Jul. 8, 2013.
(60) Provisional application No. 62/019,062, filed on Jun. 30, 2014.

(51) Int. Cl. B42F 3/04

(52) U.S. Cl. CPC B42F 3/04

(57) ABSTRACT

A binder apparatus, and methods of assembly, use, and doing business, provide a base binder with a ring metal removably mounted to a binder cover. In some embodiments, the binder components are all recyclable. In some embodiments, the ring metal is removably mounted to one or more binding posts and secured in position with a locking clip slides into and out of position generally transversely to the lateral length of the ring metal. The binder can include an optional outer cover, which in one embodiment can provide a continuous outer pocket between the cover and binder. The binder can also include a removable hole punch, which in one embodiment can be removably mounted to the binding posts intermediate the ring metal and base cover.

### CROSS-REFERENCE TO RELATED APPLICATIONS

This application claims priority through the applicant's prior provisional application entitled Binder Apparatus And Method Of Use And Doing Business, filed Jul. 8, 2013, Ser. No. 61/843,700, and the applicant's prior provisional application entitled Paper Punch Binder Apparatus And Method Of Use And Doing Business, filed Jun. 30, 2014, Ser. No. 62/019,062, both of which prior provisional applications are incorporated by reference in their entirety. In the event, however, of any inconsistency between this specification and anything incorporated by reference in this specification, this specification shall govern.

### APPLICANT'S VIEW OF ASPECTS OF THE PRIOR ART

Hard cover binders have long been used to removably mount, store, and remove paper and other items within the binders. One mechanism of mounting is via metal rings that can open and close. Paper and other items with mating ring passages in them can be mounted so that the metal rings penetrate the mating ring passages. Conversely, these mounted items can be removed by reversing the process—opening the rings and sliding the items off of the opened ring sections.

Hard cover binders have commonly long been made of three chipboard sections: a front cover section, a back cover section, and a side or spine section between the front and back cover: The three chipboard sections are secured in position between opposing colored opaque sheets of PVC (polyvinylchloride) or EPP (ethyl polypropylene). The sheets are commonly RF (radio frequency) sealed at portions surrounding outer edges of each chipboard, including between adjacent parallel edges of chipboard. This sealing can be accomplished with a fully automated inline RF sealing machine or a semi-automated RF sealing turntable press. After sealing the sheets to the chipboard, the three sealed chipboard sections can be laid flat, providing what is called a “binder flat.”

Commonly, one or more additional opaque sheets also are RF sealed to the outer edges of the opaque sheets on the inside of the binder. These additional sheets can have unsealed edges, such as the upper edges, providing pockets for papers on the inside of the binder.

A clear PVC or EPP sheet is often sealed to outer edges of the binder flat, at the front cover portion and spine section upper edge. This sheet thus provides two pockets for insertion of paper or other labels: one pocket on the outside of the front cover; and a second pocket on the outer side of the binder between the opposed front cover and back cover, or spine.

A ring metal (a metal strip having a plurality of openable and closeable, typically curved arms) is typically mounted to an inner surface of a binder flat. Most commonly, the ring metal is permanently mounted to binder flat via rivets respectively penetrating mating rivet passages in the outer surface of the binder flat and in an abutting ring metal.

These permanently riveted types of ring binders create a number of problems. First, this type of ring binder does not have components that are not only easily recyclable but also easily and obviously (to the consumer) reusable. Separating the rivets in these structures is difficult and not undertaken often. Removing the rivets can often cause damage to the binder components, and the rivets themselves are not typically reusable. In other prior structures, the ring metal has been removably secured to the binder flat via threaded rivets, which can be unthreaded and removed with a screw driver.

In addition, the sealed portions of the binder flat often break during use of the binder over time. The sealing technique also typically encloses the associated chipboard, making removal of the chipboard from the associated sealed PVC, EPP, or other sealed sheets difficult and impractical. The side and bottom sealed spine cover pocket also makes insertion and removal of spine or side labels difficult.

Another prior art binder is disclosed in a published U.S. patent application, No. 2007/0048075, by Cheng et al. (the “Cheng disclosure”). The ring metal of FIGS. 24-31 is said to be removably mounted to the spine section of binder flat by base plate attached to a ring binder cover by a key that slidably mounts within the base plate to hold a mounting post in position. Opposed arms on the key lock spring outwardly to lock the key lock in position with respect to the base plate. If the arms are then pushed inwardly somehow, the key lock can slide out of the base plate and allow the mounting post to be removed and, in turn, the base plate and ring metal to be separated from the binder flat.

After assembly, however, the opposed arms and their function are largely hidden from view and not obvious to a consumer or other person unfamiliar with how the binder is constructed. The consumer thus will often not recognize the ability to take the Cheng device apart and reuse the ring metal and mounting structure.

In addition, among other issues, the Cheng device is relatively complicated. It requires a base plate, key lock, ring metal, and binding post, along with, as noted above, recognition of how to utilize these components to assemble and disassemble them as and when desired. Further, the Cheng disclosure does not disclose how the opposed key lock arms would be depressed inwardly simultaneously in order to remove the key lock. Such an operation would be awkward and likely impossible for many if not most people. In the applicant's view, Chen thus does not provide a binder that would commonly be disassembled so that the parts can be reused by the user or any others for that matter.

Yet another prior art binder is disclosed in the applicant's prior published U.S. patent application, No. 2009/0304436 (, “the '436 publication,” which publication is hereby incorporated by reference). This type of binder provides a removable and reusable ring metal. The ring metal is removably mounted to the spine section by removable reusable posts and removable and reusable arched snap clamps slidably mounted within the interior of a ring metal. Each snap clamp is slidable up and down along the central longitudinal axis of the ring metal within the interior of a ring metal. In one position along that axis, the snap clamp locks the removable post in position, which in turn secures the ring metal in position with respect to the binder. In another position of the snap clamp, the removable post can be slid out with respect to the ring metal and binder, freeing the ring metal from the binder.

The applicant has discovered that the binder and binder components of the '436 publication can be improved upon. One problem with the '436 publication binder is that its snap clamp can be difficult to assemble and remove because it does not provide sufficient clearance between a mounting post and snap clamp or mounting clip. The '436 apparatus can thus be more costly to make and more difficult to assemble.

Another problem with the '436 binder is that the snap clamp rests in the center of the ring metal, along its longitudinal access. Thus, the angled part of the snap clamp can bump into paper when mounted onto the ring clamp. In addition, the '436 snap clamp can be difficult to move given the location of angled portion relatively closely to the ring on the ring metal.

In addition, the reusable ring binder is not sufficiently re-useable. If the cover is made of stiff plastic as disclosed in the '436 publication, the plastic typically will eventually crack at the hinge grooved or other bending sections as the hardcover is opened and closed repeatedly during typical use. A cracked hardcover may be reusable by repairing the cracked portion, but in applicant's experience many if not most users will not repair the hardcover. One reason this is so is due to the unattractiveness of the repaired portion of the cover. At best, users will throw at least the hardcover away for reprocessing and recycling.

The '436 publication also does not provide a sufficiently reusable ring binder with pockets. As a result, the binders disclosed by that publication also do not include external pockets for inserting labels or other matter, much less providing the ability to remove an insertion and replace it if desired.

Another aspect of the Chen and '436 binders is that they provide limited additional features. For example, they do not include a hole punch option. While users can acquire prior art portable hole punches having ring metal mounting holes in them and mount them in the rings of a ring binder, these types of hole punches consume substantial mounting space within the rings. They also can easily be lost or misplaced when removed, such as possibly during use of the punch, lending it to another, etc.

One such prior art punch the Swingline portable hole punch is has metal punches permanently mounted in plastic. These differing materials are not easily separated and re-used.

### BRIEF SUMMARY OF SOME ASPECTS OF THIS SPECIFICATION

The applicant believes that he discovered on or more of the issues and problems with prior art apparatus such as described above. Accordingly, there are multiple aspects of novelty, problem solution, and advantage provided by the apparatus and methods of the present specification. It is understood that identification of an aspect in this Brief Summary shall not be limiting.

In one aspect, the binder includes a removable ring mount securable in position on a base binder cover by a removable binding post securable in position by a removable clip that interlocks with the post by sliding the clip to engage the post laterally. In certain embodiments, the lateral travel is transverse to the axis of the ring mount. Some embodiments can include multiple binding posts and clips. Some embodiments can also include a spring surrounding the binding post to urge the clip to seat about the associated post structure and secure the ring mount in position on the binder.

In certain embodiments, the base binder cover may be formed of recyclable material, such as cardboard, chipboard, or stiff plastic sheet sections. Some embodiments can have various sections of such material bonded or sealed together, and these bonded or sealed portions can provide flexible hinges for the base binding cover. One or more additional sheets of flexible material can be bonded or sealed to one or more such sections to provide one or more additional pockets on the base binding cover.

In some embodiments, the base binder can be covered by a protective cover, such a plastic cover for example. Some instances of the protective cover can be formed of two sheets of plastic bonded together with a continuous opening at one edge. The base binder cover can be inserted into the protective cover through that opening.

In another aspect, an outer binder cover can be formed of sheets of flexible material bonded or sealed at the edges to form opposed base cover pockets in which the base cover can be mounted. In some embodiments, the outer binder cover can provide openings at or adjacent an edge of the cover sheets. In certain instances, these openings are adjacent the upper edge of the mating cover sheets, so that one or more removable indicia bearing sheets can be removably inserted between the outside surface of the base binding and the outer side of the outer binder cover.

In another aspect, the binder cover can provide one or more additional interior binder pockets. In some embodiments, a binder flat section mounted within the cover can cooperatively provides one or more openable pockets between binder flat section and cover.

In yet a further aspect, the binding cover can be reusable by replacing one or more cover stiffeners. Some embodiments, the stiffeners can be made of recyclable and, when not damaged excessively, reusable material. In some embodiments the cover sheets are made of recyclable and, when not damaged excessively, reusable material.

In another aspect, the entire binder can be made of recyclable and, when not damaged excessively, reusable material. In certain embodiments for example: the cover sheets are made of recyclable plastic; the cover stiffeners are made of recyclable chipboard, cardboard, or plastic; the ring metal is made recyclable metal, and the mounting hardware is made of recyclable metal or plastic.

Some embodiments of the binder can include a portable hole punch mounted within the binder. Some instances can be removably mounted within the binder. In some applications, the hole punch can include binding post passages so that the hold punch can be mounted to binding posts such as, for example, the binding posts described above. In certain instances, the hole punch can be mounted to the binding posts intermediate the binder cover and the ring metal. Some embodiments can be obviously removable and recyclable by the user or other entity. In some embodiments, hole punch components can be readily replaced when worn or damaged, so that a hold punch can be easily repaired and reused with still adequate original components.

Some embodiments of the binder can be shipped assembled or broken down in varying degrees. In certain embodiments, the binder is shipped completely broken down, and the supplier, contractor, or user can easily and quickly assemble the binder by hand. In some instances, the binder can similarly be easily and quickly disassembled by hand to varying degrees and/or completely. Any desired replacement parts can be procured and readily utilized in reassembling the binder. In some instances, the ability to readily dissemble the binder by hand is obvious to the ordinary user, to provide ease of, and incentive for, recycling or reusing one or more components of the binder.

As additional aspect provides a binder having a reduced carbon footprint as compared to prior art binders. Reduction in the carbon footprint can be improved in at least some embodiments made of components that completely recyclable and, when in sufficiently acceptable condition, reusable or replaceable by the user.

Another aspect is that some embodiments can provide a binder that is economical to make, ship, assemble, and use. A still further aspect is that certain embodiments can be, in addition or the alternative, economical to disassemble and recycle or reuse the various components as desired, substituting other components as needed to rebuild the binder. Another aspect provides a binder assembly that is easily identified by an ordinary user as one that can be disassembled, repaired, and recycled as desired.

Yet a further aspect is that some embodiments of the binder enable a binder replacement parts business and market. A still further aspect is that some embodiments can encourage further education about design and use of reusable and recyclable products. Some embodiments can encourage and expand use of persons with disabilities to assemble, repair, and/or recycle the binders or components of the binders.

As noted above, there are other novel aspects, problem solutions, and advantages disclosed in this specification. They will become apparent as this specification proceeds. In addition, it is to be understood that certain novel aspects of the present disclosure need not address an issue set forth the Background. Rather, the Applicant's Views and Brief Summary sections are solely for providing some information about this disclosure without limiting it to any content in these sections. The scope of the invention is thus to be determined by the claims as issued and not by whether, with respect to a given such claim, it addresses issues, or provides features, set forth in these sections.

### DESCRIPTION OF THE DRAWINGS

The applicant's preferred and other embodiments are shown in the accompanying drawings in which:

FIG. 1A is a plan view of an assembled binder, with optional flexible outer cover, opened flat and having components that are all recyclable, replaceable, and re-useable (if not damaged excessively by use);

FIG. 1B is a side elevational view of the binder of FIG. 1 A.

FIG. 1C is a generally cross-sectional view taken through section line 1C-1C in FIG. 1 and generally showing the area encircled by circle 1C′ in FIG. 1B during assembly of the binder;

FIG. 2A is a plan view of the assembled binder of FIG. 1 but closed and oriented vertically upwardly;

FIG. 2B is a generally cross-sectional view of the assembled binder of FIG. 2A through a plane coplanar with section line 1C-1C of FIG. 1; and

FIG. 2C is an expanded view of the cross-sectional area A in FIG. 2B (through section line 1C-1C in FIG. 1);

FIG. 3A is an exploded view showing the components of the binder of FIG. 1 and the method of assembly of the base binder along with an optional outer cover;

FIG. 3B is a plan view of the resulting assembled binder when assembled as set forth in FIG. 3A;

FIG. 4 is a plan view of the binder's cover having an outer plastic pocket sheet bound or sealed at the bottom and side edges of the cover;

FIG. 5A is a plan view of an alternative embodiment of an open ring binder with a portable three hole punch removably mounted intermediate the binder cover and ring metal;

FIG. 5B is a perspective view of the open ring binder of FIG. 5A with the punch lever raised to accommodate paper being mounted and aligned in the punch;

FIG. 5A is a blow-up of encircled area A in FIG. 5B;

FIG. 5D is a plan view of the open ring binder of FIG. 5A with paper mounted in the three hole punch and punch lever lowered over the paper in preparation for punching three holes in the paper, for subsequent ring mounting of the paper via the punched holes;

FIG. 6 is an exploded view of the components of the hole punch of FIG. 5A;

FIG. 6A is a cross-sectional side view of the hole punch base also shown in perspective in FIG. 6;

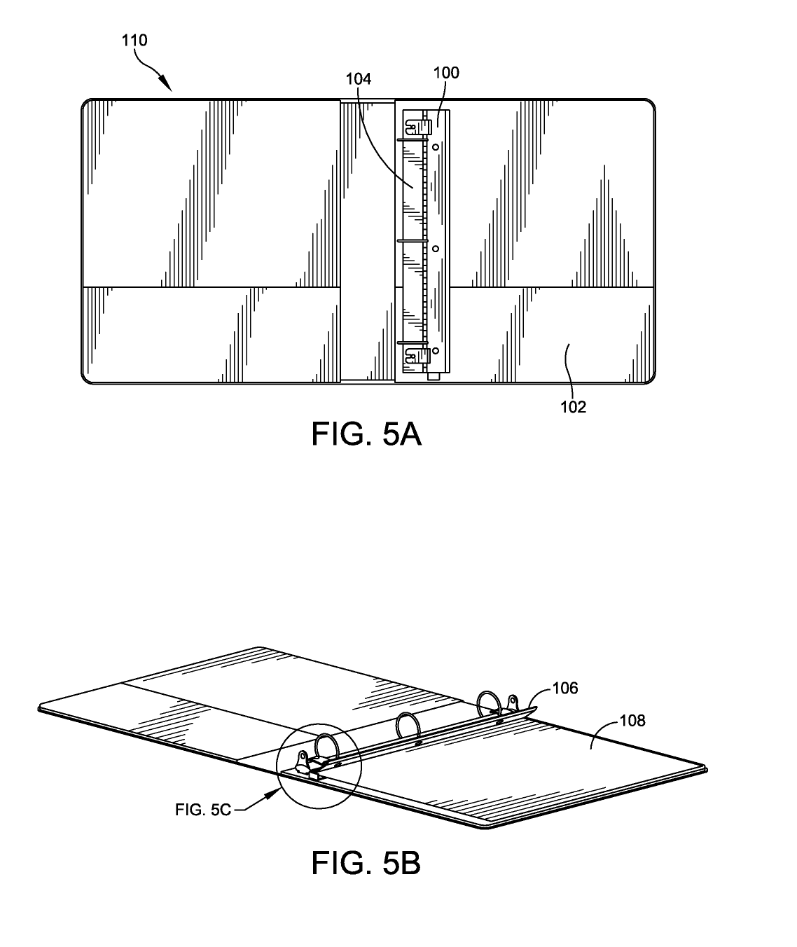

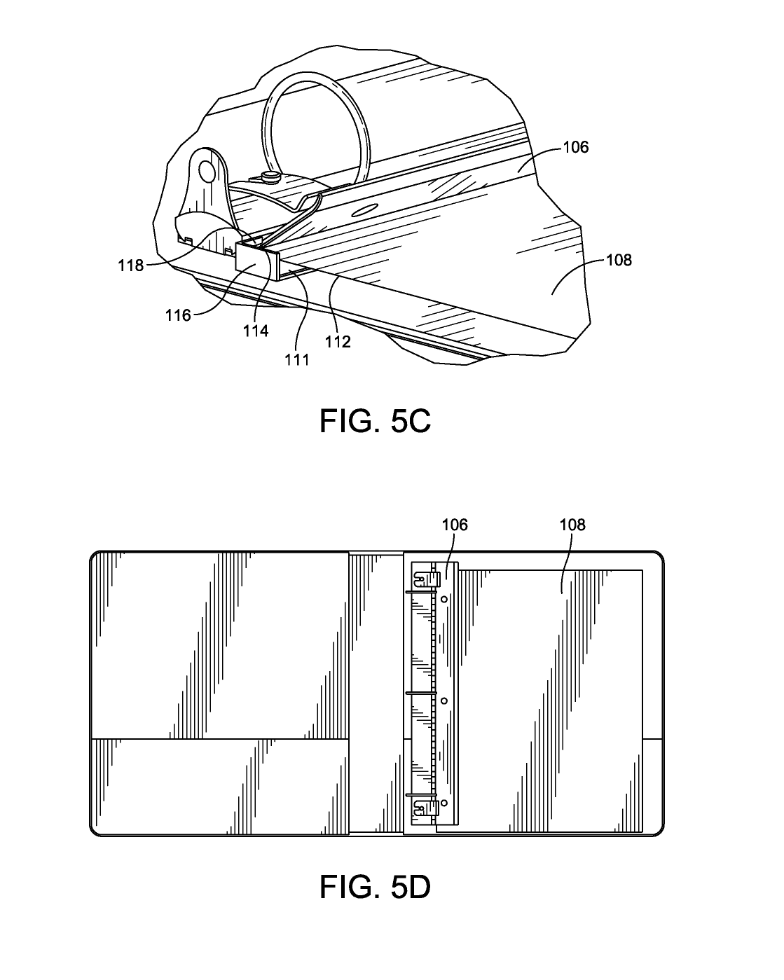

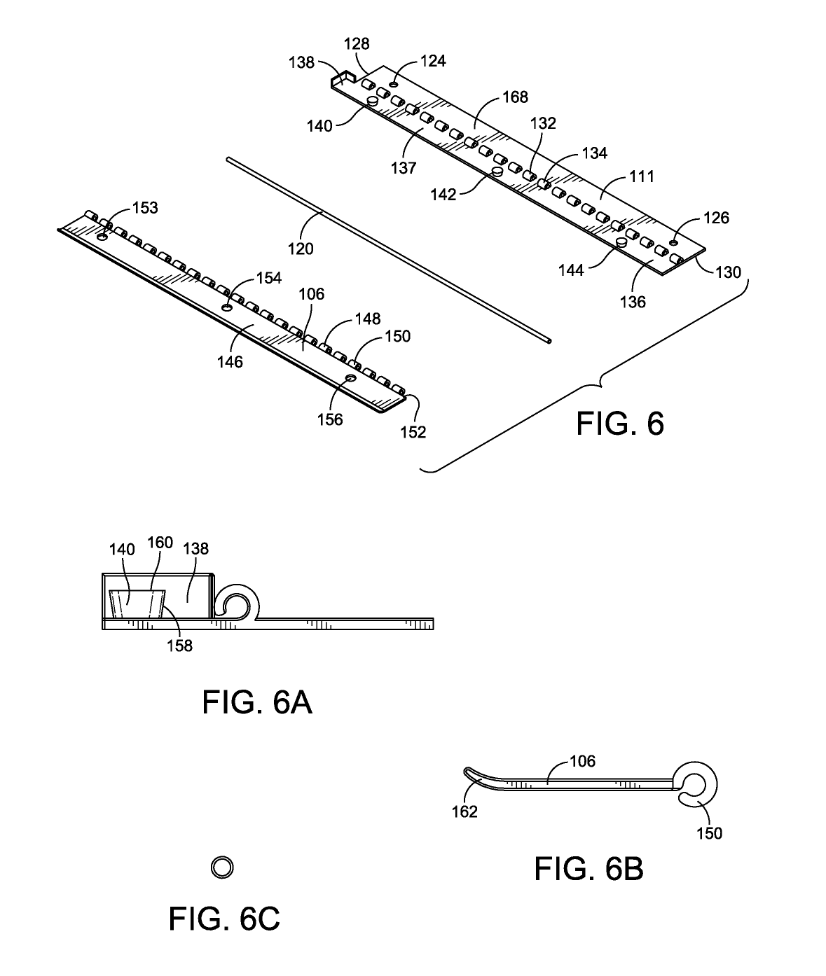

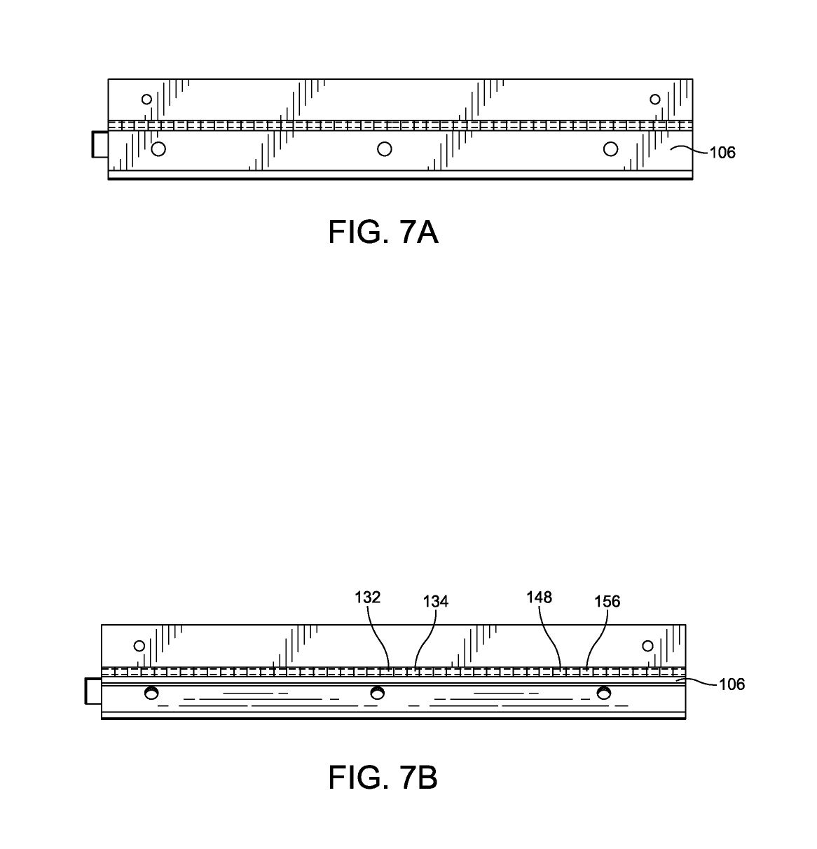

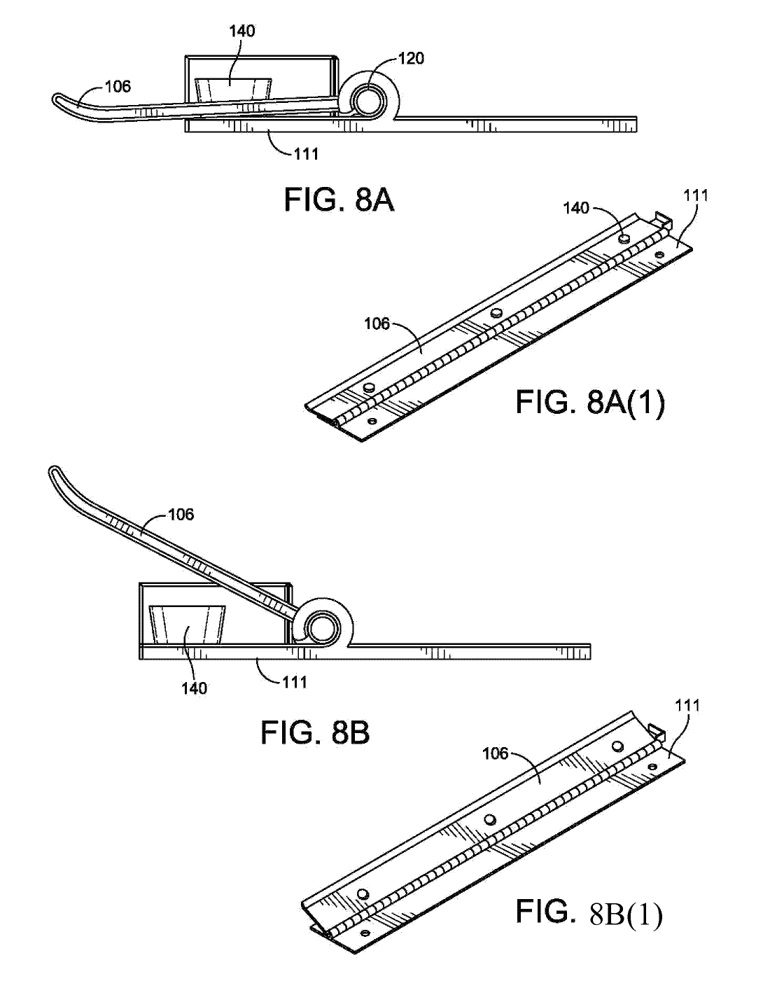

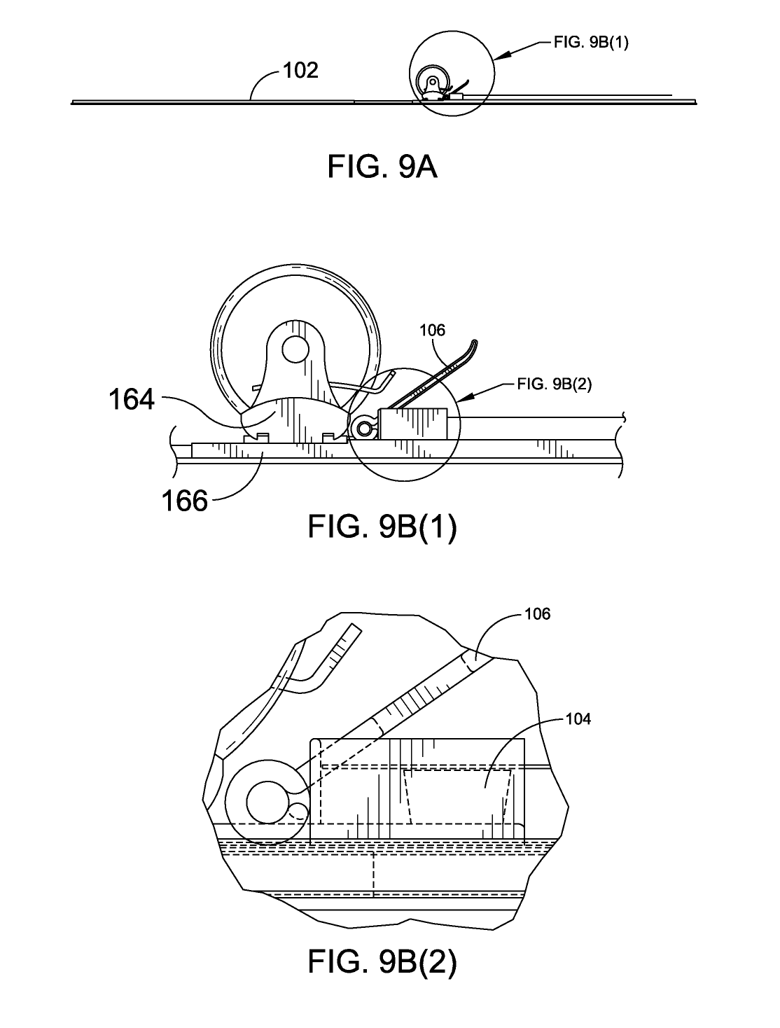

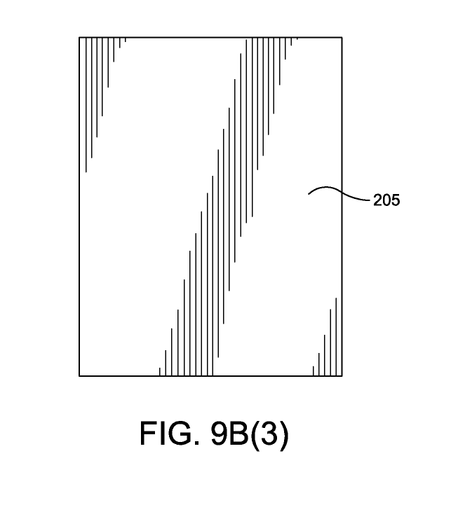

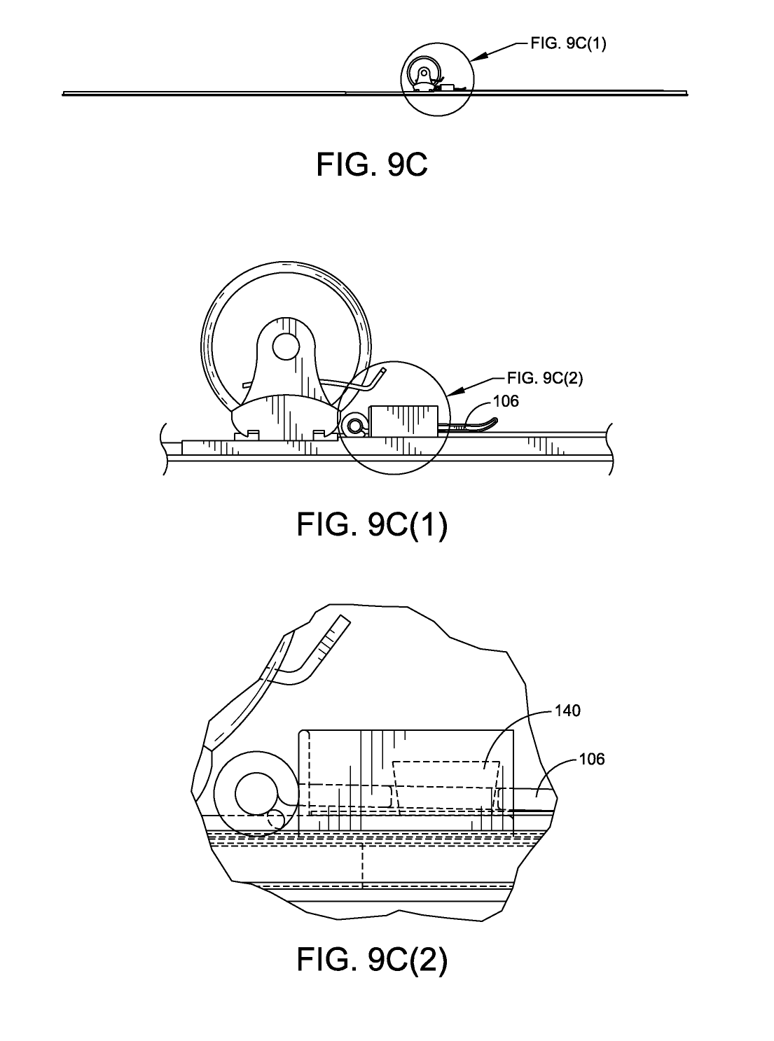

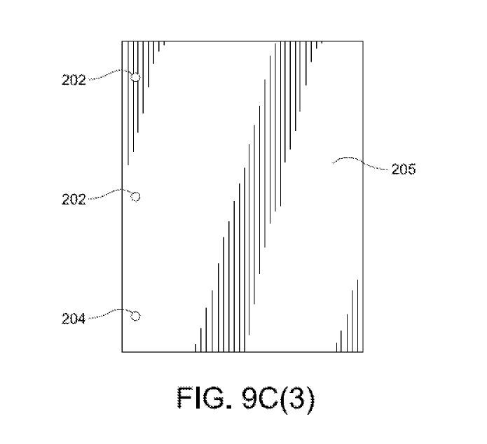

FIG. 5B is a cross-sectional side view of the hole punch lever shown in perspective in FIG. 6;

FIG. 5C is a side elevational view of the hole punch hinge pin shown in perspective in FIG. 6;

FIG. 7A is plan view of the hole punch of FIG. 5A with the punch lever in a closed position;

FIG. 7B is a plan of the hole punch of FIG. 5A with the punch lever in an open position;

FIG. 8A is side cross-sectional view of the hole punch of FIG. 5A with the punch lever in a closed position;

FIG. 8A(1) is a perspective view of the hole punch shown in FIG. 8A;

FIG. 8B is side cross-sectional view of the hole punch of FIG. 5A with the punch lever in an open position;

FIG. 8B(1) is a perspective view of the hole punch shown in FIG. 8B;

FIG. 9A is an elevational view of the open binder of FIG. 5A with the punch lever in an open position;

FIG. 9B(1) is an expanded view of the encircled area B in FIG. 9A;

FIG. 9(B)(2) is an expanded and more detailed view of the encircled area C in FIG. 9B(1);

FIG. 9B(3) is a plan view of a sheet of paper prior to mounting in the open punch of FIG. 9A;

FIG. 9C(1) is an expanded, partial bottom-side elevational view of punch lever closed;

FIG. 9C(2) is an expanded and more detailed view of the encircled area E in FIG. 9C(1); and

FIG. 9C(3) is a plan view of a sheet of paper after being punched in the punch of FIG. 9C(1);

In this specification, various spacially orienting terms are used, such as “upper,” “lower,” “front,” “back,” and “side.” It is to be understood that these terms are use to aid in understanding the description of components with respect each other in one common orientation, but these terms are not meant to require a particular orientation in space.

### DETAILED DESCRIPTION

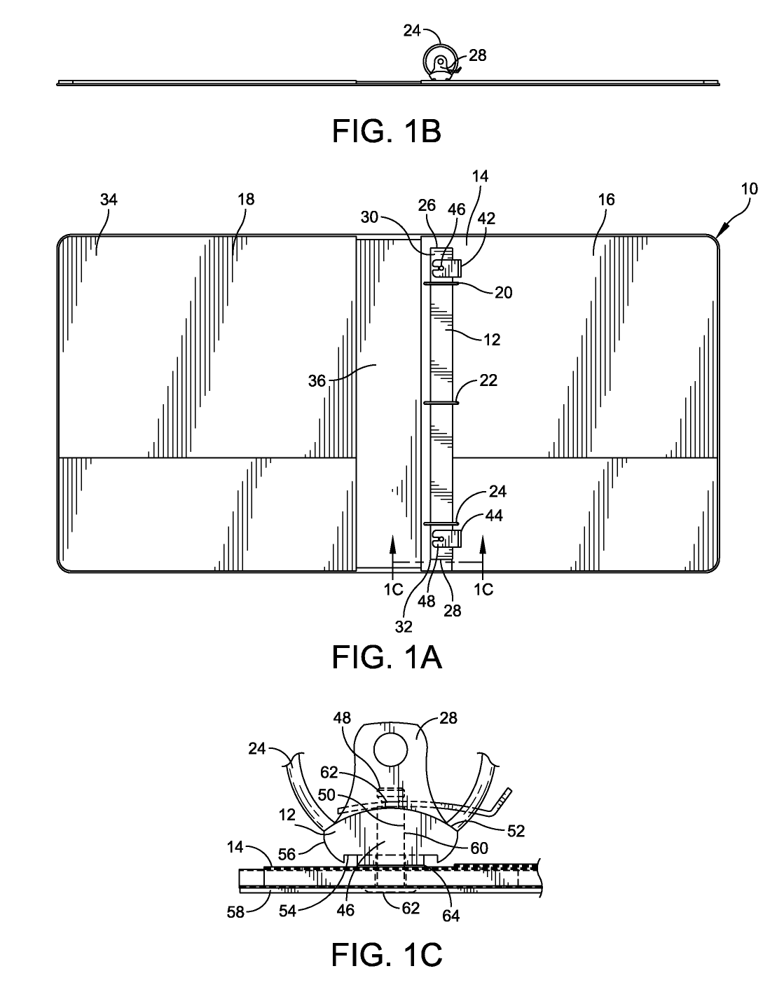

With reference to FIGS. 1A-C, one embodiment of a binder, generally 10, has a ring metal 12 secured to the interior surface 14 of the back cover section 16 of a generally planar binder flat 18. The ring metal 12 has three alternately openable and closeable metal rings 20, 22, 24 spaced from each other laterally along the lateral length of ring metal 12. The rings 20, 22, 24 can be opened or closed in a conventional manner by moving a top lever 26 and bottom lever 28 located respectively at opposed top 30 and bottom 32 ends of the ring metal 12, or by pulling or pushing the rings 20, 22, 24 by hand as applicable. It is understood that the ring metal could include any number of rings as desired or required for a given binder or binder application.

The binder flat 18 has a front cover section 34 and a side cover section 36 intermediate the front cover section 34 and the back cover section 16. The back cover section 16 has an outer laterally extending side 38 opposite an inner laterally extending side 40. The ring metal 12 is removably mounted to the back cover section 16 adjacent and parallel to the inner laterally extending side 40 of the back cover section 16.

The ring metal 12 is secured in position on the back cover section 16 by removable upper 42 and lower 44 locking clips that respectively clip to the mating upper 46 and lower 48 metal mounting posts generally transverse to, for example, the interlocking portion of the mounting posts 42, 44. Each locking clip, e.g., 42, is located intermediate an adjacent associated end, e.g., upper end 30, and ring, e.g., 20. As a result, it is obvious to the ordinary person that locking clips 42, 44 are secured in position with the interlocking associated mounting posts 46, 48, respectively, and can be removed to remove the ring metal 12 from the underlying binder flat 18. Similarly, due to the location of the ring metal 18 on the back cover 16, it is obvious that the locking clips 42, 44 can be removed by merely sliding them (i) away from the mounting posts 42, 44, (ii) generally parallel to the interior surface 14 of the back cover, and (iii) generally perpendicular to the central lateral axis A-A along the lateral length of the ring metal 12, all without bumping into other structure.

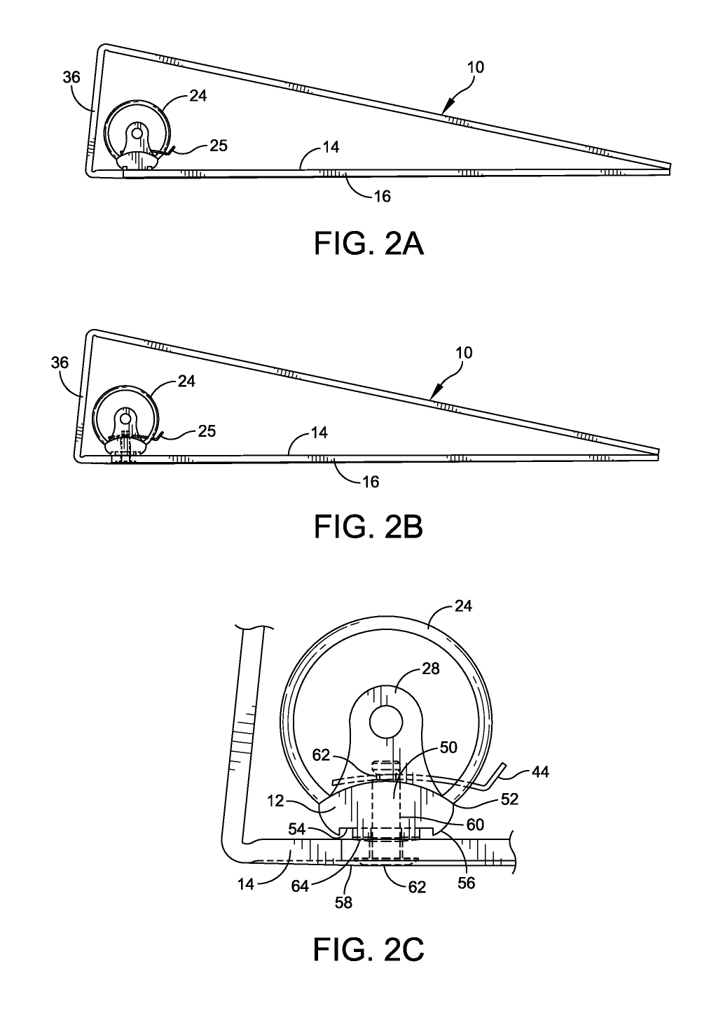

With reference now to FIGS. 2A-C, the binder 10 folds to provide the front cover 34, side cover 36, and back cover 16 sections surrounding materials (not shown) to be mounted within the folded binder 10. In the embodiment shown in FIG. 2B, the lower locking clip 46 extends from the ring metal 12 generally parallel to the interior surface 14 of the back cover 16. Other configurations of the clip 46 can be utilized, such as one that extends from the ring metal 12 downwardly toward the interior surface 14 of the back cover 16, providing more room for paper or other materials mounted within the rings, e.g., 24, of the ring metal 12.

Referring next to FIG. 2C, the ring metal 12 includes a lock post passage 50 extending from the upper curved surface 52 of the ring metal 12 transversely downwardly to penetrate a spring washer seat or upwardly extending depression 54 in the otherwise curved lower side surface 56 of the ring metal 12. The mounting post 46 extends from the exterior side 58 of the back cover section 16 through the lock post passage 50 to extend above the upper curved surface 52 of the ring metal 12. The mounting post 48 thus has a relatively narrower central post section 60 intermediate a relatively widened and flattened end 62 and a clip-mating slotted upper end 62 extending upwardly from the upper curved surface 52 of the ring metal 12. The locking clip 42 is somewhat L-shaped with a curved or arched central, laterally extending section 51, a finger-actuable lip 53 extending upwardly at an angle from the arched central section 51, and a slotted interlocking end 55 opposite the finger actuable lip 53. A spring washer 64 is mounted about the central post section 60 within washer seat 54 to bias (i) the widened end 62 to firmly abut the back cover exterior side 58 and (ii) the associated locking clip 42 in locking position within and surrounding the slotted upper end 62, so that the locking clip 42 firmly abutting the adjacent portion of the curved upper surface 52 on the ring metal 12.

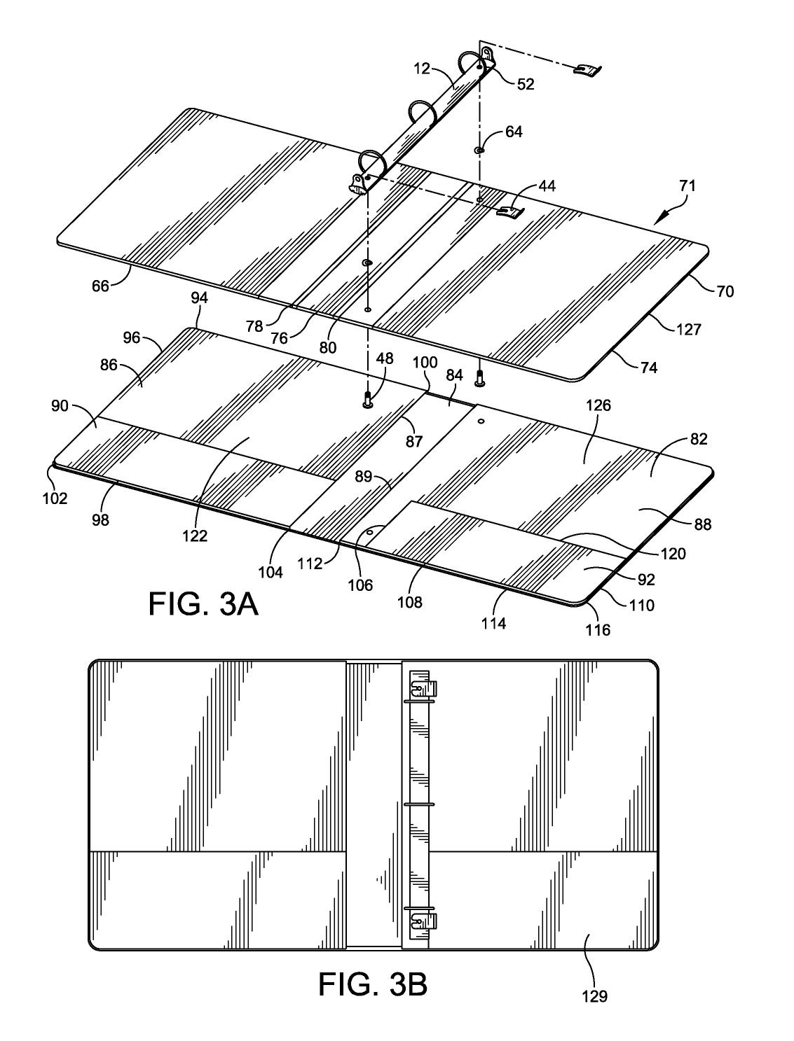

With reference to FIG. 3A, a method of assembly of another embodiment of a binder 71 is as follows.

1. Form a foldable basic binder flat section 70 with a chipboard front cover section 72, a chipboard back cover section 74, a chipboard spine section 76. Secure the spine section 76 intermediate the front cover section 72 and the back cover section 74 with binding tape 75 so that front 78 and rear 80 hinge portions of the binding tape 75 spanning between the these sections 72, 74, 76 provide a front flexible hinge portion 78 and a back flexible hinge portion 80 respectively.
2. Optionally, form an additional flexible plastic cover 82 with an outer cover section 84, a front inner cover pocket section 86, a back inner cover pocket section 88, a front cover inner pocket section 90, and a back cover inner pocket section 92. The front and back inner cover pocket sections 86, 88 are each secured to the outer cover section 84 in the same manner: for example, the top 94, outer side 96, and bottom edges 98 of the front inner cover section 86 are RF sealed to mating edges, 100, 102, 104, respectively, of the outer cover section 84. The front 86 and back 88 inner cover pocket sections thus provide openable inner front and back cover pocket edges 87, 89 respectively.

The front and back inner pocket sections 90, 92 are each secured in position in the same matter: for example, the inner side 106, bottom 108, and out outer side 110 edges of the back inner pocket section 92 are RF sealed to mating edges 112, 114, 116, respectively, on the back inner cover pocket section 88. The front and back inner pocket sections 90, 92 thus provide openable inner front and back pocket edges 118, 120 respectively.

The various components of the plastic cover 82 may be colored as desired. Differing shapes and sizes can be included as desired, or pockets can be deleted as desired.

The binder cover 82 may be made of or include materials other than plastic. For example, the binder cover could be made of leather and include differing types of pockets and mounting structure, such as pen mounting slots as but one example.

3. Assemble the basic binder 71 as follows:
place the mounting posts 46, 48 through the mounting post passages 47, 49, respectively, in the binder cover 82;
place the spring washers 64, 65 over the mounting posts 46, 48, to abut the inside surface 77 of the binder cover 82;
mount the ring metal 12 on the mounting posts 46, 48 so that the mounting posts 46, 48 penetrate mounting post passages 51, 53, respectively, in the ring metal 12;
press the ring metal 12 toward the adjacent portion of the insider surface 77, compressing the spring washers 64, 65 between the ring metal 12 inside surface 77 of the binder cover 82;
slide the locking clips 42, 44 generally perpendicularly to the axis A-A of the ring metal 12 so that, with respect to locking clip 44 for example, the slotted upper end 55 of the locking clip 44 surrounds the matingly slotted upper end 62 of the binding post 46; and
release the pressure on the ring metal 12 and spring washers 64, 65, allowing the locking clip 44 to firmly abut the adjacent opposed portions of (i) the curved upper surface 52 on the ring metal 12 and (ii) slotted upper end 62 of the binding post 46.
   The friction fit of each locking clip, e.g., 46, between the binding post 46 and ring metal 12 secures the ring metal 12 so that it abuts the inside surface 77 of binder cover 82 and provides a completed base binder assembly 71.

Various pockets and labels could be added to this binder assembly. Pockets could be glued, taped, or otherwise secured to various surfaces, such as on the insider of the front or back cover sections 72, 74.

If desired, the flexible (or other) binder cover 82 can be added as follows:
slide (i) an outer side edge 102 of the front inner cover section 86 to penetrate the front inner cover pocket area 122 through the inner pocket edge 118, and (ii) the outer side edge 124 of the back inner cover section 88 to similarly penetrate the back inner cover pocket area 126 through the inner back cover pocket edge 89. Continue sliding the opposed ends 125, 127 of the binder flat section 70 all the way into the binder cover 82, yielding a completed binder assembly with flexible cover 129 as shown in FIG. 3B.

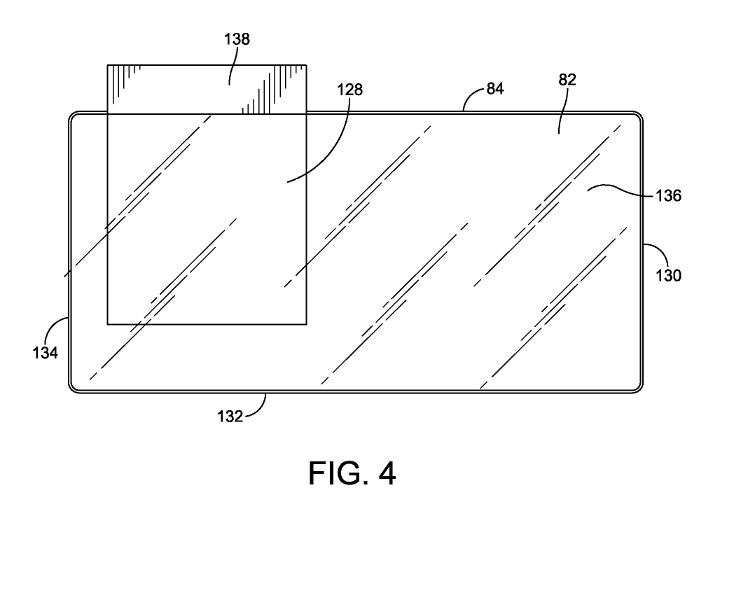

Turning now to FIG. 4, the flexible binder cover 82 can optionally include an outer pocket 128, such as one made or plastic and by RF sealing the front 130, bottom, 132, and back 134 edges of a cover pocket plastic sheet 136 to mating front, bottom, and back edges (not shown in FIG. 4) of a plastic outer cover section 84. When mounted on the base binder assembly 71 (not shown in FIG. 4), the outer pocket 128 and opposing outer surface of the base binder assembly can thus provide a continuous pocket (with no sealed hinge sections) in which one or more paper or other inserts, e.g., paper insert 138, may be inserted. The inserts can include various indicia or colors (not shown) that can then be visible through the plastic sheet 136 if made of clear or sufficiently transparent plastic.

One problem with prior art outer pockets is that inserting and removing an insert in the spine area of prior art plastic cover can be difficult because of sealed hinges otherwise typically provided at the front and rear sides of the spine area. This embodiment 82 includes no such spine sealing for the outer plastic pocket 128, so that insertion and removal of inserts into the spine and other areas of the binder can be easily accomplished by opening the binder. Further, if desired a given insert, e.g., 138, can be made less likely to move around insider the outer pocket 128 by use of two-sided tape (not shown) on the back side (not shown) of the insert 138 and securing the two-sided tape at that desired location within the interior (not shown) of the outer pocket 128.

The binder assemblies 71, 129 may be disassembled by generally reversing the assembly methods described above. For example, when opened and laid on a flat surface, manually pressing down on the upper surface 52 of the ring metal 12, relieves friction force between the upper locking clip 42 and mounting post 46. The locking clip 42 can be removed easily, without the aid of a tool. After removing both the upper and lower clips 42, 44 in this fashion, the ring metal 12 can then be lifted off of the mounting posts 46, 48. The metal spring washers 64, 66 can then be easily removed by hand or by turning the binder flat section 70 over and letting them fall off. By sliding the outer cover 82 away from the spine section 76 of the binder flat section 70, the remaining posts 46, 48 are easily removed by hand and by falling away from the binder flat section 70. Finally the plastic cover 82 simply slides off of the remainder of the binder flat 76.

The ordinary consumer can see that, for example, that the binder assembly 129 can be separated into three distinct materials: metal, paper, and plastic. Upon inspecting each of the parts, undesired, damaged, or broken can be removed and sent for reprocessing recycling or stored such as by placement in a recycle bin.

If the binder assembly is to be rebuilt, a new or satisfactory stored part can then be substituted for the removed part. The remaining satisfactory parts from the original binder assembly can thus be reused and the binder can be reassembled and continue to perform its function. Alternatively, the remaining satisfactory parts from the disassembled binder can be stored for later use.

These processes can be repeated over and over for a virtually unlimited period of time. None of the binder parts need be sent to a landfill.

The applicant uses the mark, Ecofit, to refer the binder assemblies 71, 129 generally shown, and described in association with, FIGS. 1A-4 of this specification. The Ecofit™ Binder can thus:
be shipped in a broken down state;
be sold to the consumer in a broken down state;
be easily assembled by a supplier or consumer;
be disassembled and completely recycled or repaired by a supplier or ordinary consumer, including with replacement components as desired or needed; and
provide a market for replacement parts.

In contrast to prior art ring binders designed for a throw away consumer market, the Ecofit™Binder has a positive impact on the environment by reducing waste, extending the life span of the product, reducing the volume of the materials that enter into our landfills, and reducing the transportation costs and fuel consumption to distribute the product. The Ecofit™Binder also provides a substantially smaller carbon footprint while having more combined, easily used features than prior art binders.

One way the Ecofit™ Binder can provide such positive environmental impact is by addressing the problem of making the product of the type that the average person will recognize as (i) being easily assembled and disassembled, and (ii) having components that can be replaced and recycled. When the Ecofit™ Binder is opened, it is easily seen that the ring metal is not riveted to the binder flat. The unique ring metal locking clip mechanism is visible and easily recognized as a fastener holding everything together and that can be removed to separate the components from each other.

In addition, in the center of the Ecofit™Binder below the ring metal, the chipboard spine is exposed to view. The user can also readily see that the chipboard components can be removed from the plastic cover, so that worn components can not only be replaced but also easily recycled.

The ease of disassembly, repair, and replacement of the Ecofit™ Binder can increase the useful life of the product as well as provide the consumer a cost savings by not having to purchase an entire new binder as one or more parts become damaged or worn. A ring metal mechanism, for example, can thus have a useful lifespan spanning generations of people. The Ecofit™ Binder can thus provide a smart substitute for the traditional riveted ring binders that currently dominate the marketplace and for other prior art binders as well.

Consumers are often willing to pay for more features. The Ecofit™ Binder, for example, can be offered in a basic binder form and in multiple configurations of added features. For example, a basic binder without a clear overlay or outer cover can be upgraded by procuring a plastic cover with a clear overlay or with other features, such as differing pockets arrangements or types of pockets (such as a pen pocket for example). The user can thus add optional features to the Binder, including at a later time.

The plastic cover can be made entirely of clear plastic, providing the user with ability to add unique, customizable styling or labeling, with partial or unique full coverage stylizing across the front, back, and spine. The clear overlay provides protection and easy access to the pockets to insert art or typeset across the entire back, as well as a unique inside overlay on the front and back inner cover sections. Alternatively, the plastic cover can be made of colored or black plastic; and other types of covers, such as a cover made partially or wholly of fabric, can be provided to the basic binder when desired.

As shown in the Figures, the flexible binder cover can contain two interior horizontal pockets and two additional vertically pockets provided by the chipboard front and back sections and the mating front and inner back cover sections of the plastic cover. Paper is less likely to fall out of the vertical pockets or be seen by others when mounted in these pockets. As noted above, however, the flexible cover may be eliminated and the basic binder used without any cover if desired.

An alterative embodiment of a Ecofit™ binder, generally 110, is disclosed in association with FIGS. 5A-9C(3) and includes a novel three hole punch 100 mounted between a binder cover 102 and ring metal 104. This binder 110, less the hole punch 100, of this embodiment can be the same as the types of binders disclosed above, or it can be structured in many other ways disclosed in the prior art or otherwise known to those of skill in the art.

In the shown embodiment, the hole punch 100 has a lateral length approximately the same as, or slightly larger than, the lateral length of the ring metal 104. Other sized punches may be utilized of course.

With reference to FIGS. 5A-5D, the hole punch lever 106 can be rotated upwardly to open the hole punch 100 to mount and align a sheet of paper 108 or other material within the punch 100. As shown in FIG. 5C, the paper 108 can be aligned within the punch base 111 so that the bottom edge 112 and side edge 114 of the paper 108 abut the mating, upwardly extending bottom 116 and inner 118 planar sides of the punch base 111.

With reference to FIG. 6, the punch 100 has three main components: the punch base 111, the punch lever 106, and punch hinge pin 120. The punch base 111 has a generally planar bottom side 122 with two post mounting passages 124, 126 adjacent opposed lateral ends 128, 130 of the punch base 111. The punch base 111 also has coaxial hinge rod mounting rings, e.g., 132, 134, extending laterally from on lateral end 128 to another lateral end 130 of the punch base 111. The punch paper mounting section 137 is on the lateral side 136 of the punch base 111 opposite the post mounting passages 124, 126. The paper mounting section 136 includes a paper alignment corner 138 extending from the upper end 128 of the punch base 111. Three co-aligned cylinder paper-punching blades 140, 142, 144 extend perpendicularly upwardly from the punch base 111.

The punch lever 106 has a generally planar body 146 with coaxial lever hinge mounting rings, e.g., 148, 150, extending outwardly from one laterally extending side 152 of the punch lever 106. The hinge pin 120 is hollow (as shown in FIG. 6C) and sized to slide within the interior periphery of a hinge channel (not shown in FIG. 6) created by the intersection of the lever hinge mounting rings. e.g., 148, 150, and the matingly spaced hinge rod mounting rings, e.g., 132, 134. The punch lever 106 has three punching blade passages 153, 154, 156 laterally aligned to matingly surround the paper-punching blades 140, 142, 146.

As shown in FIGS. 6 and 6A, the blades, e.g., 140, each have a conical outer periphery 158 abutting a planar upper cutting surface 160 extending transversely to the conical outer periphery 158. As shown in FIG. 6B, the punch lever 106 also has an upwardly curved lifting edge 162 opposite the lever hinge mounting rings, e.g., 148, 150.

With reference now to FIGS. 7A and 7B, when the punch 100 is assembled, the punch lever 106 is rotatable about the hinge pin (not shown in FIGS. 7A and 7B) within the hinge channel (id.) formed within the co-aligned and matingly spaced lever hinge mounting rings, e.g., 148, 150 and hinge rod mounting rings, e.g., 132, 134. Referring to FIGS. 8A, 8A(1), 8B, and 8B(1), when the punch lever 106 is closed down toward the punch base, the punching blades, e.g., 140, penetrate the mating punching blade passages (not shown in FIGS. 8A and 8B) in the punch lever 106. With reference to FIGS. 9B(3) and 9C(3), the punch can thus be used to punch holes, e.g., 200, 202, 203, in a sheet of paper 205.

With reference to FIGS. 9A, 9B(1), 9B(2), 9C, 9C(1), and 9C(2), the punch 100 is removably assembled to the binding cover 102 by modifying the assembly technique described above for the embodiment of FIGS. 1A-4. After mounting the mounting posts (not shown in FIG. 9B(1)) in the binding cover 166 and before mounting the ring metal 164 to the mounting posts and binding cover 166, the binding post mounting section 168 of the punch base 111 (see FIG. 6) is mounted to abut the binding cover 166 with the mounting posts penetrating the matingly located and sized post mounting passages 124, 126 in the mounting post mounting section in the ring metal 164. Then, the ring metal 164 is mounted to the portion of the mounting posts extending upwardly from the binding post mounting section 168 of the punch base 111. This structure is all then removably bound together in the same fashion as described for the FIG. 1A-4 embodiment.

The components of the punch 110 can be made of any suitable materials, such as plastic or metal for example. In one embodiment, all the components are composed of metal, rendering the punch 110 repeatedly re-useable as well as recyclable. If the punch blades, e.g., 140, become worn, the punch base 111 can be replaced so that the punch lever 106 and hinge pin 120 can be re-used with a replacement punch base 111.

In the depicted embodiment of the punch 100, the punch 110 is not mounted within the mounting rings in the ring metal 164. In addition, the punching portion of the punch 100 provided by the punch lever 106 and associated paper mounting and punching structure are spaced laterally away from the mounting rings. The punch 100 is thus a part of the binder 110, and portable with it, while reducing consumption of mounting space in the mounting rings of the ring metal 104.

Some embodiments of the disclosed binder products can be marketed to provide consumers with more choices about assembling of the products, the components to be included in a given binder, and the means of acquiring these products. Further, because some embodiments can be shipped in knocked-down form, it is not only less expensive to ship but also supportive of being assembled, easily, by either the user or the distributor or other supplier, including for example supplier employees or contractors that have special needs and abilities or are otherwise disadvantaged.

Applicant believes that a large volume of ring binders are imported into the U.S. in assembled form from other, often far away, countries. Some embodiments of the disclosed binders can have a substantial positive impact on the environment and energy consumption by being shipped in knocked-down form, reducing overall transportation costs as well and providing employment opportunities for binder assembly in the U.S. or other locale as desired.

This new method of offering certain embodiments of the disclosed binders (or variations of them) can provide a number of benefits to humans and local communities. Schools, governments, organizations, businesses, and individuals can save money on the purchase of binder components and either assemble themselves or procure the assembly of the product by others, which can help bring work into a local community.

Many disclosed embodiments can raise awareness of the need to renew and reuse components and then only recycle only the component(s) that will no longer perform properly. The products can be used by teachers as teaching aids in the schools and can help educate a future generation of consumers on the use and design of products that are more sustainable than the current throw away products that are offered in the market place. With this distribution and business method, bad habits can begin to be changed over time. Such binders (for example, the particular Ecofit™ Binders shown in the accompanying drawings) can raise awareness and help eliminate the Throw Away Mentality.

As used herein, the term “recycling” can mean reuse of a binder component to provide a repaired or rebuilt binder or reprocessing of a binder component, such as by reprocessing of damaged chipboard to provide a new chipboard or other product made by reprocessing the chipboard.

I claim:

1. A ring binder apparatus comprising in combination:
A. a binder cover having a binder cover binding post passage;
B. a binding post removably mountable in the binding post passage and having a securing clip channel end opposite a binder cover abutting end;
C. a ring mount having a lateral length with a lateral axis extending along the lateral length of the ring mount, a paper mounting side opposite a binding cover mounting side, a plurality of paper mounting rings extending from the paper mounting side and spaced along the lateral length of the ring mount, and a ring mount binding post passage extending from the paper mounting side to the paper mounting side, the paper mounting side having a rounded or arched external periphery; and
D. a removable locking clip having a locking end opposite a finger actuable end and a curved laterally extending section intermediate the locking end and finger actuable end, the laterally extending section having a curved laterally extending cross-section whereby the removable locking clip is slidably mountable into securing clip channel of the binding post along the curved external periphery of the ring mount substantially perpendicularly to the lateral axis of the ring mount.

2. The ring binder apparatus of claim 1 wherein the binding cover has a stiff front cover section, a stiff back cover section, and a stiff side cover section taped to the stiff front cover section and stiff back cover section.

3. The ring binder apparatus of claim 2 wherein the binder cover has flexible binder cover having an open upper end and containing the stiff front cover section, stiff back cover section, and stiff side section.

4. The ring binder apparatus of claim 3 wherein the stiff front section, stiff back section, and stiff side section are removably mountable through the open upper end of the flexible binder cover.

5. The ring binder apparatus of claim 4 wherein the stiff front section, stiff back section, and stiff side section are removably mountable through open upper end of the flexible binder cover.

6. The ring binder apparatus of claim 6 wherein the open upper end of the flexible binder cover is open from a front side edge of the binding cover to an opposing back side edge of the binding cover.

7. The ring binder apparatus of claim 1 wherein the binding cover comprises translucent polymeric material, and the binding post, ring mount, and removable locking clip comprise metal.

8. The ring binder apparatus of claim 6 wherein the flexible binding cover comprises translucent polymeric material, the stiff front cover section, stiff back section, and stiff side section comprise recyclable material, and the binding post, ring mount, and removable locking clip each comprise metal.

9. The ring binder apparatus of claim 6 wherein the flexible binding cover consists dominantly of translucent polymeric material, the binding post, ring mount, and removable locking clip each consist dominantly of metal, and the stiff front conver section, stiff back cover section, and stiff side cover section consist dominantly of plastic, paper, or chipboard

10. The ring binder apparatus of claim 2 wherein the binder cover consists essentially of recyclable materials.

11. The ring binder apparatus of claim 6 wherein the binder cover consists essentially of recyclable materials.

12. The ring binder apparatus of claim 10 wherein the binding post, ring mount, and removable locking clip consist essentially of recyclable material.

13. The ring binder apparatus of claim 11 wherein the binding post, ring mount, and removable locking clip consist essentially of recyclable material.

14. A ring binder apparatus comprising in combination:
A. a binder cover having a binder cover binding post passage;
B. a ring mount having a lateral length with a lateral axis extending along the lateral length of the ring mount, a paper mounting side opposite a binding cover mounting side, paper mounting rings extending from the paper mounting side and spaced along the lateral length of the ring mount, and a ring mount binding post passage extending from the paper mounting side to the paper mounting side, the binding cover mounting side abutting the binder cover;
C. a binding post having a securing end opposite a binder cover abutting end and being removably mounted in the binder cover binding post passage and the ring mount binding post passage, the securing end including a locking clip channel; and
D. a removable locking clip removably mounted in the locking clip channel of the binding post along the paper mounting side of the ring mount substantially perpendicularly to the lateral axis of the ring mount.

15. The ring binder apparatus of claim 14 wherein the ring binder apparatus consists essentially of recyclable material.

16. The ring binder apparatus of claim 15 wherein the binder cover consists dominantly of paper-based material and the ring mount, binding post, and locking clip consist essentially of metal.

17. The ring binder apparatus of claim 16 wherein the removable locking clip has a ring mount mating central section intermediate a binding post interlocking end opposite a finger actuable lip end, the finger actuable lip section extending at an angle from the ring mount mating central section.

18. A ring binder assembly kit comprising in combination and in at least partially disassembled form:
A. a binder cover flat having a binder cover binding post passage;
B. a binding post removably mountable in the binding post passage and having a securing clip channel end opposite a binder cover abutting end;
C. a ring mount having a lateral length with a lateral axis extending along the lateral length of the ring mount, a paper mounting side opposite a binding cover mounting side, a plurality of paper mounting rings extending from the paper mounting side and spaced along the lateral length of the ring mount, and a ring mount binding post passage extending from the paper mounting side to the paper mounting side, the paper mounting side having a rounded external periphery; and
D. a removable locking clip having a locking end opposite a finger actuable end and a curved laterally extending section intermediate the locking end and finger actuable end, the laterally extending section having a curved laterally extending cross-section, whereby the removable locking clip is slidably mountable into securing clip channel of the binding post along the curved external periphery of the ring mount substantially perpendicularly to the lateral axis of the ring mount.

19. The unassembled ring binder kit of claim 18 wherein binder cover flat, the binding post, the ring mount, and the removable locking clip consist essentially of recyclable material.

20. A ring binder distribution method comprising procuring the ring binder kit of claim 19 and shipping the ring binder assembly kit.

21. A ring binder assembly method comprising making a ring binder by:
removably mounting a removable binding post through a ring cover post passage in a ring binder cover and a ring metal post passage in a laterally extending ring metal having a lateral length and a relatively shorter width; and
removably sliding a locking end of locking clip into a mating locking channel in the removable binding post generally perpendicularly to a laterally extending axis along the lateral length of the ring metal.

22. The ring binder assembly method of claim 21 further comprising:
mounting a front cover section and back cover section in a flexible, transparent cover of the binding cover.

23. The ring binder assembly method of claim 20 wherein ring binder consists essentially of recyclable material.

24. The ring binder assembly method of claim 21 wherein ring binder consists essentially of recyclable material.
